(19) United States
(12) Patent Application Publication
(10) Pub. No.: US 2015/0047459 A1
(43) Pub. Date: Feb. 19, 2015

(54) ROTATOR DRIVING SYSTEM AND IMAGE FORMING APPARATUS WITH SAME

(71) Applicants: Katsuaki MIYAWAKI, Kanagawa (JP); Tetsuo WATANABE, Kanagawa (JP); Hiromichi MATSUDA, Kanagawa (JP); Kimiharu YAMAZAKI, Kanagawa (JP)

(72) Inventors: Katsuaki MIYAWAKI, Kanagawa (JP); Tetsuo WATANABE, Kanagawa (JP); Hiromichi MATSUDA, Kanagawa (JP); Kimiharu YAMAZAKI, Kanagawa (JP)

(73) Assignee: Ricoh Company, Ltd., Tokyo (JP)

(21) Appl. No.: 14/447,173

(22) Filed: Jul. 30, 2014

(30) Foreign Application Priority Data
Aug. 15, 2013 (JP) 2013-169020
Dec. 25, 2013 (JP) 2013-268143

(51) Int. Cl. F16F 15/315

(52) U.S. Cl. CPC F16F 15/315
USPC 74/574.4

(57) ABSTRACT

A rotator driving system for driving a rotator with a motor includes a dynamic vibration absorber attached to a rotary shaft of the rotator. The dynamic vibration absorber includes an inertia body, a viscosity-providing component to provide a viscosity, and a torsion spring unit to function as a torsion spring that includes a boss fixed to the rotary shaft. Multiple spokes extend radially outward from the boss. Multiple seats are provided at respective tips of the multiple spokes to fix the inertia body. The torsion spring unit is fixed by both the rotary shaft of the rotator and the boss fixed to the rotary shaft therebetween. The viscosity-providing component supports the inertia body via the multiple seats provided at the respective tips of the multiple spokes.

### CROSS-REFERENCE TO RELATED APPLICATION

This patent application is based on and claims priority pursuant to 35 U.S.C. §119(a) to Japanese Patent Application Nos. 2013-169020, filed on August 15, 2013, and 2013-268143, filed on Dec. 25, 2013, respectively, in the Japan Patent Office, the entire disclosures of which are hereby incorporated by reference herein.

### BACKGROUND

1. Technical Field

Embodiments of this invention relate to a rotator driving system for a rotating a rotator, such as a photoconductive drum, a roller, etc., employed in an image forming apparatus or the like, and to an image forming apparatus with the same. In particular, embodiments of the present invention relate to a rotator driving system that has a dynamic vibration absorber to suppress fluctuation in rotational speed of the rotator, and the image forming apparatus with the same.

2. Related Art

Conventionally, when a rotational speed of a photoconductive drum employed in an image forming apparatus fluctuates, a scanning pitch accordingly changes in a sub-scanning direction, resulting in so-called banding, i.e., uneven density occurs in an image. To reduce such banding, a flywheel coaxial with the axis of the photoconductive drum is typically employed.

For such a configuration, however, since the fluctuation in rotational speed of the photoconductive drum is suppressed by using a larger flywheel, the size and weight of the apparatus is increased.

To suppress the fluctuation in rotational speed of the photoconductive drum without increasing the size of the flywheel, a configuration is known that includes a dynamic vibration absorber having an inertia body with a small diameter. One such system employs a dynamic vibration absorber that includes an annular inertia body disposed around a drive shaft with a ring of rubber interposed therebetween, which rotates together with a photoconductive drum.

In this configuration, design parameters of the dynamic vibration absorber, such as spring constant and viscous damping coefficient are determined by the rubber ring that supports the annular inertia body.

Other conventional systems include a dynamic vibration absorber, in which an inertia body is attached to a first rotator while sandwiching an elastic member therebetween. As in the above-described former conventional dynamic vibration absorber, spring constant and viscous damping coefficient design parameters are adjusted and set based on a single elastic member such as rubber, etc. The inertia body is supported on a support shaft (e.g., a rotary shaft of a photoconductive drum) via bearings.

In yet other conventional systems, a pair of inertia moment (herein below, simply referred to as inertia) adjusting devices is provided at different sections around an outer circumference of the inertia body to precisely set the spring constant to an optimal value, thereby omitting any fluctuation when it occurs therein by precisely adjusting the inertia.

To optimize the viscosity-providing component, the dynamic vibration absorber is generally made of rubber to utilize its large viscosity.

### SUMMARY

One aspect of the present invention provides a novel rotator driving system for driving a rotator with a motor that includes: a dynamic vibration absorber attached to a rotary shaft of the rotator. The dynamic vibration absorber includes: an inertia body; a viscosity-providing component to provide a viscosity; a torsion spring unit that includes a boss fixed to the rotary shaft, at least two spokes extending radially outward from the boss, and at least one seat provided at one of tips of the at least two spokes to fix the inertia body. The torsion spring unit is fixed by both the rotary shaft of the rotator and the boss fixed to the rotary shaft. The torsion spring unit also supports the inertia body via the at least one seat provided at one of tips of the at least two spokes.

Another aspect of the present invention provides a novel rotator driving system for driving a rotator with a motor that includes a dynamic vibration absorber attached to a rotary shaft of a rotator. The dynamic vibration absorber includes: a first inertia body not fixed to the rotary shaft in its rotational direction; at least two torsion spring units each extending radially outward from the rotary shaft while connecting to the first inertia body and the rotary shaft at its both ends, respectively; a viscosity-providing component supporting unit fixed to the rotary shaft; and a viscosity-providing component made of viscoelastic rubber connected to the first inertia body and the rotary shaft via the viscosity-providing component supporting unit. An amount of inertia and a spring constant of the dynamic vibration absorber are adjusted by moving a coupling position of the torsion spring unit coupled with the first inertia body in the radial direction in accordance with a variation in viscosity characteristics of the viscosity-providing component.

Yet another aspect of the present invention provides a novel image forming apparatus having a rotator driving system. The rotator driving system includes a dynamic vibration absorber attached to a rotary shaft of the rotator. The dynamic vibration absorber includes: an inertia body; a viscosity-providing component to provide a viscosity, a torsion spring unit that includes a boss fixed to the rotary shaft, at least two spokes extending radially outward from the boss, and at least one seat provided at one of tips of the at least two spokes to fix the inertia body. The torsion spring unit is fixed by the rotary shaft of the rotator and the boss fixed to the rotary shaft. The torsion spring unit supports the inertia body via the at least one seat provided at one of tips of the at least two spokes.

### BRIEF DESCRIPTION OF THE DRAWINGS

A more complete appreciation of the present invention and many of the attendant advantages thereof will be more readily obtained as substantially the same becomes better understood by reference to the following detailed description when considered in connection with the accompanying drawings, wherein:

FIG. 1 is a block diagram schematically illustrating an overall image forming section included in a copier as an image forming apparatus according to one embodiment of the present invention;

FIG. 2 is a plan view schematically illustrating an exemplary rotator driving system for a photoconductive drum system, to which a dynamic vibration absorber of a first embodiment of FIG. 1 is applied, according to one embodiment of the present invention;

FIG. 3A is a cross-sectional view illustrating an exemplary dynamic vibration absorber according to one embodiment of the present invention;

FIG. 3B is a perspective view of the dynamic vibration absorber when it is taken from a site of a rotator according to one embodiment of the present invention;

FIG. 3C is a perspective view illustrating the dynamic vibration absorber when it is taken from an opposite site of the rotator according to one embodiment of the present invention;

FIG. 4 is a diagram illustrating the other example of a torsion spring unit provided in the dynamic vibration absorber according to one embodiment of the present invention;

FIG. 5 is a diagram illustrating an example of the dynamic vibration absorber, in which coaxial precision of the inertia body and the rotary shaft is increased by using a torsion spring unit according to one embodiment of the present invention;

FIG. 6 also is a diagram illustrating another example of the dynamic vibration absorber, in which coaxial precision of the inertia body and the rotary shaft is increased by using a torsion spring unit according to one embodiment of the present invention;

FIG. 7 is a diagram illustrating frequency response characteristics of a drive transmission system from a driving motor to a photoconductive drum acting as the rotator in the configuration shown in FIGS. 3A to 3C (i.e., FIG. 2) according to one embodiment of the present invention;

FIG. 8 is a diagram illustrating an exemplary rotator driving system having a flywheel around its rotary shaft, to which a dynamic vibration absorber of a second embodiment of the present invention is applied to minimize rotational fluctuation of a rotator according to one embodiment of the present invention;

FIG. 9 is a diagram illustrating frequency response characteristics of a drive transmission system extended from a driving motor to a photoconductive drum acting as a rotator in the configuration as shown in FIG. 8, in which a dynamic vibration absorber is disposed in a rotator driving system having a flywheel, according to one embodiment of the present invention;

FIG. 10A is a perspective view illustrating another type of the dynamic vibration absorber employing different types of torsion spring units when it is taken from an opposite site of a rotator according to another embodiment of the present invention;

FIG. 10B is a perspective view of the different type of the dynamic vibration absorber of FIG. 10A when it is taken from a site of the rotator according to one embodiment of the present invention;

FIG. 11 is a perspective view illustrating another type of the dynamic vibration absorber employing different types of multiple torsion spring units when it is taken from an opposite site of a rotator and second inertia bodies are located at original positions according to another embodiment of the present invention;

FIG. 12 is a diagram illustrating yet another example of the dynamic vibration absorber, in which coaxial precision of the inertia body and the rotary shaft is enhanced by using a viscosity-providing component supporting member according to one embodiment of the present invention;

FIG. 13 also is a diagram illustrating yet another example of the dynamic vibration absorber, in which coaxial precision of the inertia body and the rotary shaft is enhanced by using an integral supporting member according to one embodiment of the present invention;

FIG. 14 is a diagram illustrating another dynamic vibration absorber that employs different types of multiple torsion spring units with second inertia bodies extended radially from their original positions, which is taken from an opposite site of a rotator according to another embodiment of the present invention;

FIG. 15 is an expanded diagram partially illustrating an exemplary moving mechanism of the second multiple inertial members of FIG. 14 according to one embodiment of the present invention;

FIGS. 16A, 16B, and 16C are both side and partial cross-sectional views collectively illustrating a coupling mechanism coupling the torsion spring unit with the dynamic vibration absorber at an optional position according to one embodiment of the present invention;

FIG. 17 is a diagram illustrating frequency response characteristics obtained when the viscous damping coefficient of a viscosity-providing component made of rubber employed in the dynamic vibration absorber decreases due to its variation per production lot in a comparative example; and

FIG. 18 is a diagram illustrating a result of adjustment executed when the viscous damping coefficient of a viscosity-providing component made of rubber employed in the dynamic vibration absorber decreases due to its variation per production lot according to one embodiment of the present invention.

### DETAILED DESCRIPTION

In view of the above-described problems, one embodiment of the present invention establishes a dynamic vibration absorber capable of maintaining both spring and viscosity functions thereof while accurately supporting an inertia body coaxially with an axis of a rotary shaft. The other embodiments of the present invention provide a rotator driving system capable of reducing fluctuation in speed and an image forming apparatus with the rotator driving system as well.

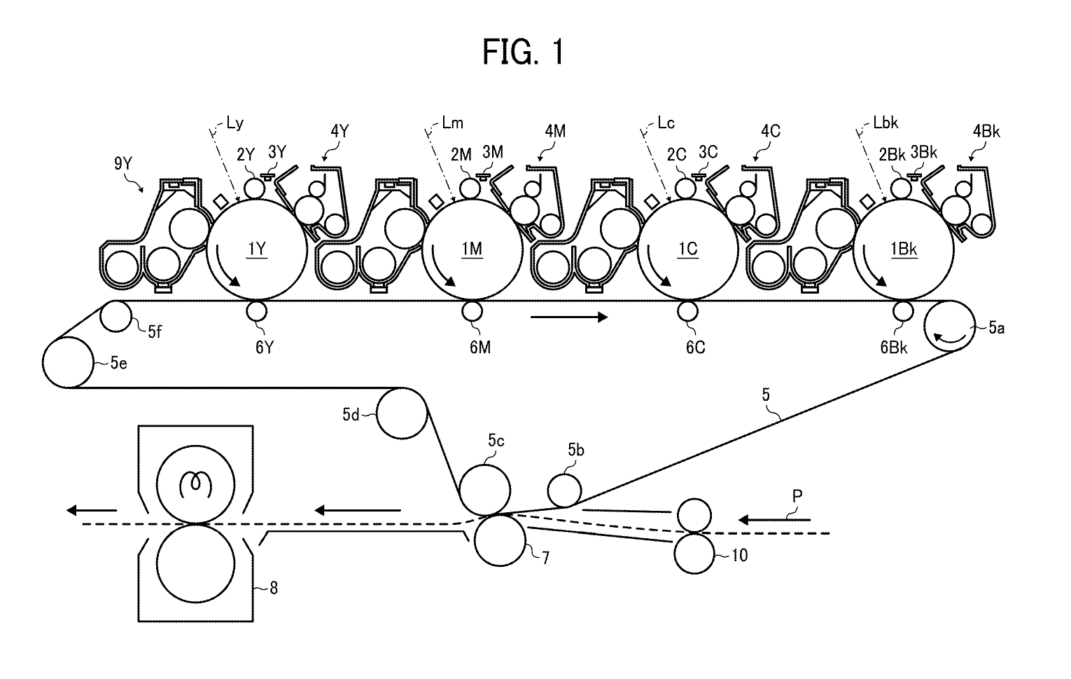

Referring now to the drawings, wherein like reference numerals designate identical or corresponding parts throughout the several views thereof and in particular to FIG. 1, one embodiment of the present invention, which is applied to an electrophotographic color copier (hereinafter, sometimes simply referred to as a copier) serving as an image forming apparatus 1 is described. The copier of this embodiment is the so-called tandem type image forming apparatus that employs a dry type two-component developer system using dry type two-component developer.

Now, a first embodiment of the present invention is described with reference to FIG. 1 and the other applicable drawings. Initially, an overall image forming section included in the copier as the image forming apparatus is schematically described with reference to FIG. 1. This copier receives image data as image information from an image reader, not shown, and executes an image formation process based thereupon. As shown in FIG. 1, in the copier, four color photoconductive drums 1Y, 1M, 1C, and 1Bk, are placed side by side as rotatable latent image bearers for respective colors of yellow (herein below, abbreviated as Y), magenta (herein below, abbreviated as M), cyan (herein below, abbreviated as C), and black (herein below, abbreviated as BK). These photoconductive drums 1Y, 1M, 1C, and 1Bk are lined up side by side along an endless intermediate transfer belt 5, which is supported by multiple rotatable rollers including a driving roller, in a belt moving direction almost touching thereof. Around the respective photoconductive drums 1Y, 1M, 1C, and 1Bk, electrophotographic processing members, such as multiple electric chargers 2Y, 2M, 2C, and 2Bk, multiple developing devices 9Y, 9M, 9C, and 9Bk of different colors, multiple cleaning devices 4Y, 4M, 4C, and 4Bk, and multiple electric charge removing devices 3Y, 3M, 3C, and 3Bk, etc., are disposed in an electrophotographic processing order.

Now, an exemplary operation of forming a full-color image using the copier according to this embodiment of the present invention is described. First of all, when a photoconductive member driving system, not shown, drives and rotates the photoconductive drum 1Y in a direction as shown by arrow in the drawing, the photoconductive drum 1Y is uniformly charged by the electric charger 2Y. Subsequently, an optical device, not shown, irradiates a light beam LY and forms a Y-electrostatic latent image on the photoconductive drum 1Y. This Y-electrostatic latent image is subsequently developed by the developing device 9Y with Y-color toner included in the developer. During the development, a given developing bias is applied between a developing roller and the photoconductive drum 1Y, so that the Y-color toner on the developing roller electrostatically adheres onto a portion of a Y-electrostatic latent image on the photoconductive drum 1Y.

The Y-color toner image developed and formed in this way is conveyed to a primary transfer position, at which the photoconductive drum 1Y contacts the intermediate transfer belt 5, as the photoconductive drum 1Y rotates. At the primary transfer position, a predetermined bias voltage is applied to a backside of the intermediate transfer belt 5 from a primary transfer roller 6Y. Subsequently, a primary transfer field is caused by the predetermined bias voltage applied in this way, and the Y-color toner image on the photoconductive drum 1Y is attracted toward the intermediate transfer belt 5 and primarily transferred onto the intermediate transfer belt 5 under the primary transfer field. Subsequently, an M toner image, a C toner image, and a Bk toner image are primarily transferred similarly onto the Y-color toner image borne on the intermediate transfer belt 5 to sequentially overlap with each other. In FIG. 1, it is to be noted that reference alphanumeric characters 5a to 5f respectively indicate multiple rollers including a driving roller, a driven roller, a tension roller, and an opposing roller opposed to a registration roller described later, collectively winding the intermediate transfer belt 5, for example.

The overlapped four-color toner images on the intermediate transfer belt 5 in this way is subsequently conveyed to a secondary transfer position opposed to a secondary transfer roller 7 as the intermediate transfer belt 5 rotates. Toward the secondary transfer position, a transfer sheet P (simply indicated by arrow in the drawing) is conveyed at a predetermined time by the registration roller 10. At the secondary transfer position, the secondary transfer roller 7 applies a predetermined bias voltage onto the backside of the transfer sheet P. The secondary transfer electric field caused by the predetermined bias voltage when applied and a prescribed contacting pressure caused at the secondary transfer position allows the four-color toner image to be secondarily transferred from the transfer belt 5 to the transfer sheet P at once. Afterward, the secondarily transferred toner image on the transfer sheet P is discharged outside the image forming apparatus when completing a fixing process executed by a pair of fixing rollers 8.

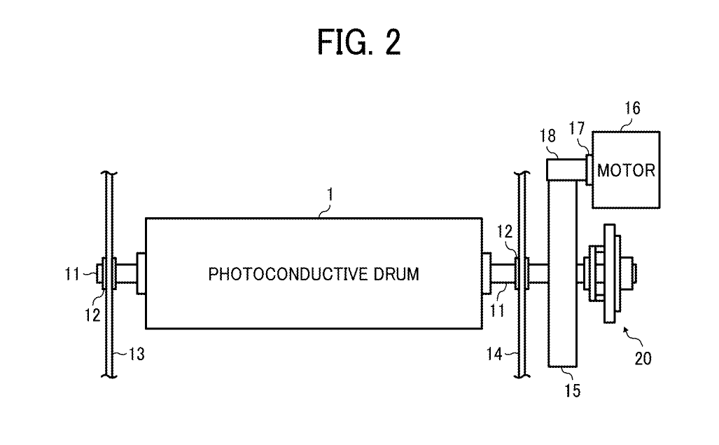

FIG. 2 illustrates an embodiment of the present invention in which a dynamic vibration absorber of one embodiment of the present invention is applied to a driving train for a photoconductive drum 1. Each of the photoconductive drums 1Y, 1M, 1C, and 1Bk (herein below, collectively indicated by the reference number 1) is mounted on a drum shaft 11 of the photoconductive drum 1 to integrally rotate therewith. The drum shaft 11 is freely rotatably supported between a pair of body front and rear side plates 13 and 14 via a pair of bearings 12, respectively. The drum shaft 11 projects outwardly from the body rear side plate 14. A driving gear 15 is attached to the drum shaft 11 to constitute a rotator driving system for the photoconductive drum 1 and integrally rotate with the drum shaft 11. The driving gear 15 engages with a motor gear 18 fixed to a motor shaft 17 of a driving motor 16 so that rotation of the driving motor 16 can be communicated to rotate the photoconductive drum 1. A dynamic vibration absorber 20 is installed to one end of the drum shaft 11 extended outside the driving gear 15 (i.e., a side away from the body rear side plate 14).

The Y-color toner image developed and formed in this way is subsequently conveyed to the primary transfer position, in which the photoconductive drum 1Y and intermediate transfer belt 5 come into contact with each other as the photoconductive drum 1Y rotates. At the primary transfer position, the primary transfer roller 6Y applies the predetermined bias voltage onto the backside of the intermediate transfer belt 5. Subsequently, under a primary transfer field caused by the predetermined bias voltage applied, the Y-color toner image on the photoconductive drum 1Y is attracted toward the intermediate transfer belt 5 and is primarily transferred onto the intermediate transfer belt 5. Subsequently, an M toner image, a C toner image, and a Bk toner image are similarly primarily transferred onto the Y-color toner image on the intermediate transfer belt 5 to sequentially overlap with each other.

The toner images of the four color borne overlapped on the intermediate transfer belt 5 in this way is subsequently conveyed to the secondary transfer position opposed to the secondary transfer roller 7 as the intermediate transfer belt 5 rotates. Toward the secondary transfer position, a transfer sheet P is conveyed at a predetermined time by the registration roller 10. At the secondary transfer position, the secondary transfer roller 7 applies the predetermined bias voltage onto the backside of the transfer sheet P. Thus, a contacting pressure at the secondary transfer position and the secondary transfer electric field generated by the bias voltage when applied collectively allow the toner image on the transfer belt 5 to be secondarily transferred onto the transfer sheet P at once. Afterward, a secondarily transferred toner image on the transfer sheet P is discharged outside the image forming apparatus after completing a fixing process executed by a pair of fixing rollers 8.

Hence, according to this embodiment of the present invention, since the torsion spring unit and the viscosity-providing component respectively serving as design parameters for the dynamic vibration absorber 20 are secured by different parts respectively, each of these parameters can be easily optimized when designed. That is, since the torsion spring unit and the viscosity-providing component are conventionally constituted by a common single part by contrast such that the rubber provides both the torsion spring function and the viscosity function, for example, designing and setting of the parameter is cumbersome. According to the first embodiment of the present invention, however, the designing and setting of the parameter can be easily executed considerably. In addition, as described later more in detail, when the torsion spring unit is formed in spoke shape to exert a twisting function to twist the rotator, a space can be saved in a direction in parallel to the drum shaft 11. Hence, by simply forming the torsion spring unit in spoke shape, the spring constant can be easily set based only a length, a cross-sectional area, and the number of the spokes without changing a size of the dynamic vibration absorber 20. Further, the spring constant also can be set based only on an inner diameter, an outer shape, and a thickness of the cylinder of the viscosity-providing component as well.

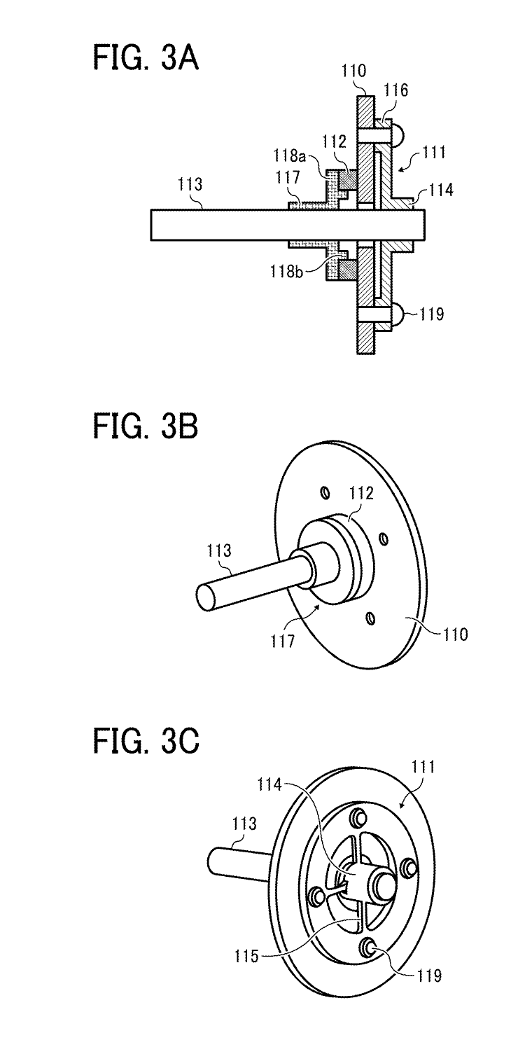

Now, a dynamic vibration absorber according to one embodiment of the present invention is described with reference to FIGS. 3A to 3C herein below. FIG. 3A is a cross-sectional view illustrating the dynamic vibration absorber 20. FIG. 3B is a perspective view of the dynamic vibration absorber 20 when it is taken from a site of a rotator. FIG. 3C is a perspective view illustrating the dynamic vibration absorber 20 when it is taken from an opposite site of the rotator. The dynamic vibration absorber 20 of FIGS. 3A to 3C is used in a rotator driving system for driving a rotator such as a photoconductive drum, etc. The dynamic vibration absorber 20 includes an inertia body 110, a torsion spring unit 111, and a viscosity-providing component 112. The inertia body 110 is preferably composed of a disc-shaped metal having a heavy specific gravity. The torsion spring unit 111 is preferably configured by including a boss 114 secured to the rotary shaft 113, multiple spokes 115 extending radially outward from the boss 114 toward an outer circumference, and multiple seats 116 disposed at respective tips of the spokes 115 to fix the inertia body 110. That is, the torsion spring unit 111 is fixed by the boss 114 to the rotary shaft 113 while fixing and supporting the inertia body 110 with the seats 116.

The viscosity-providing component 112 is preferably composed of a cylindrical viscoelastic material. The viscosity-providing component 112 maybe sandwiched and accordingly fixed by a supporting unit 117 and the inertia body 110 therebetween fixed to the rotary shaft 113.

Now, first of all, the torsion spring unit material is herein below described more in detail. The torsion spring unit 111 includes a boss 114 with a hole at its center, through which the rotary shaft penetrates, multiple spokes 115 extending radially outward from a perimeter of the boss 114 at even intervals, and an outer rim having contact surfaces on its outer circumference to contact and fix the inertia body. The torsion spring unit 111 is fixed to the rotary shaft at the boss 114. A fixing method of fixing the torsion spring unit 111 can be appropriate chosen. For example, a prescribed method can be adopted to stop rotation of the torsion spring unit 111, such as a screw fixing method, a D-shape or oval shape fitting method of fitting a shaft into a hole, etc. The other fixing method can be also employed as well.

The inertia body 110 is fixed to the outer rim of the torsion spring unit 111 with multiple screws 119 and is supported by an annular protrusion 118b in a floating condition not to directly contact the rotary shaft 113 as described later more in detail. Hence, while receiving weight and inertia of the inertia body 110, the spokes 115 exert a torsion spring function when the inertia body 110 rotates and vibrates. Here, a prescribed step is desirably formed in its cross section between the outer rim of the torsion spring unit 111 and the spokes 115 so that the spokes 115 do not contact the inertia body 110. With this, since the inertia body 110 does not interference with torsion spring function (i.e., motion to absorb the vibration of the inertia body 110 in its rotating direction), which is generally caused by the contact thereof, the torsion spring function is more considerably exerted precisely.

Here, although the number of spokes 115 is four in this embodiment as illustrated in the drawing, three or more spokes 115 other than four may be desirably employed when evenly disposed in a radial direction (i.e., placed at equal angular intervals). That is, when less than two spokes 115 having a relatively too small spring constant to support a weight of the inertia body 110 and are positioned horizontally, the spokes 115 likely deflect and change its rotational speed (i.e., awkwardly rotate).

Material of the torsion spring unit 111 can be made of metal. However, elongate spokes 115 are needed to obtain a desired spring constant thereof as a problem. Consequently, not to elongate spokes 115, plastic having less rigidity than the metal is desirable. For example, polyacetal, polycarbonate, and ABS (acrylonitrile-butadiene-styrene) or the like are preferably employed. Specifically, with the plastic having a relatively small rigidity, a smaller spring constant can be readily set. By contrast, when it is required, a greater rigidity can be set by enlarging either the number or a cross-sectional area of the spokes 115. The resin also allows mass production of spokes 115 using an injection molding method while improving its productivity at low cost.

Now, the viscosity-providing component 112 is described herein below more in detail. The viscosity-providing component 112 does not necessarily have a particular shape, but typically has a cylindrical shape in this embodiment of the present invention. The viscosity-providing component 112 is preferably made of viscoelastic rubber. For example, rubber, such as NBR (Nitrile butadiene rubber), EPDM (ethylene-propylene-diene-M), NR (Natural Rubber), etc., can be employed.

The viscosity-providing component 112 has prescribed planes at its both end faces. One of the planes is concentric with the inertia body 110 and is glued thereto. The other one of the planes is also concentric with the supporting unit 117 fixed to the rotator (i.e., the rotary shaft 113) and is glued thereto as well. To effectively assemble these members by gluing, a double-sided adhesive tape made of rubber is preferably used. Otherwise, the viscosity-providing component 112 may be glued to the supporting unit 117 by vulcanizing the rubber thereof, while it is glued to the inertia body with the double-sided adhesive tape.

The supporting unit 117 is composed of a boss fixed to the rotary shaft, a flange 118a glued to the viscosity-providing component 112, and the above-described annular protrusion 118b formed on an end face of the flange 118a to fit into an inner diameter portion (i.e., an inner wall) of the viscosity-providing component 112. Accordingly, when the protrusion 118b fits into the viscosity-providing component 112, the concentric precision with the rotary shaft is upgraded, and accordingly rotational fluctuation can be reduced.

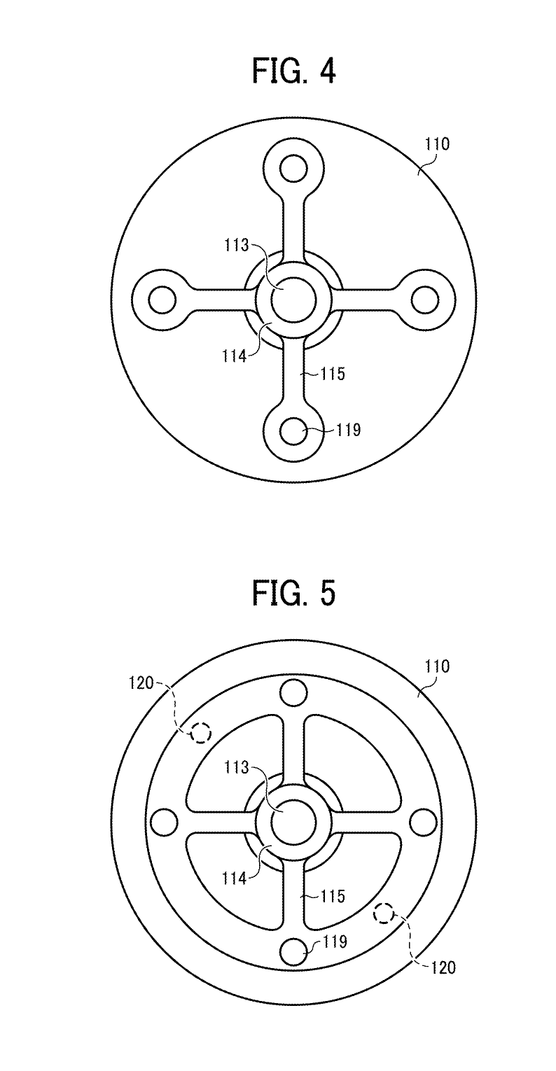

Now, another example of the torsion spring unit 111 is described herein below with reference to FIG. 4. As illustrated there, the torsion spring unit 111 has a different shape from that of the earlier described embodiment to support and secure the inertia body 110. Specifically, multiple seats are independently formed (i.e., isolated) from each other on respective tips of multiple spokes 115 extending radially outward from the boss 114 fixed to the rotary shaft 113 to collectively fix the inertia body 110. That is, the multiple seats are not connected to the other on an outer circle as different from the above-described embodiment.

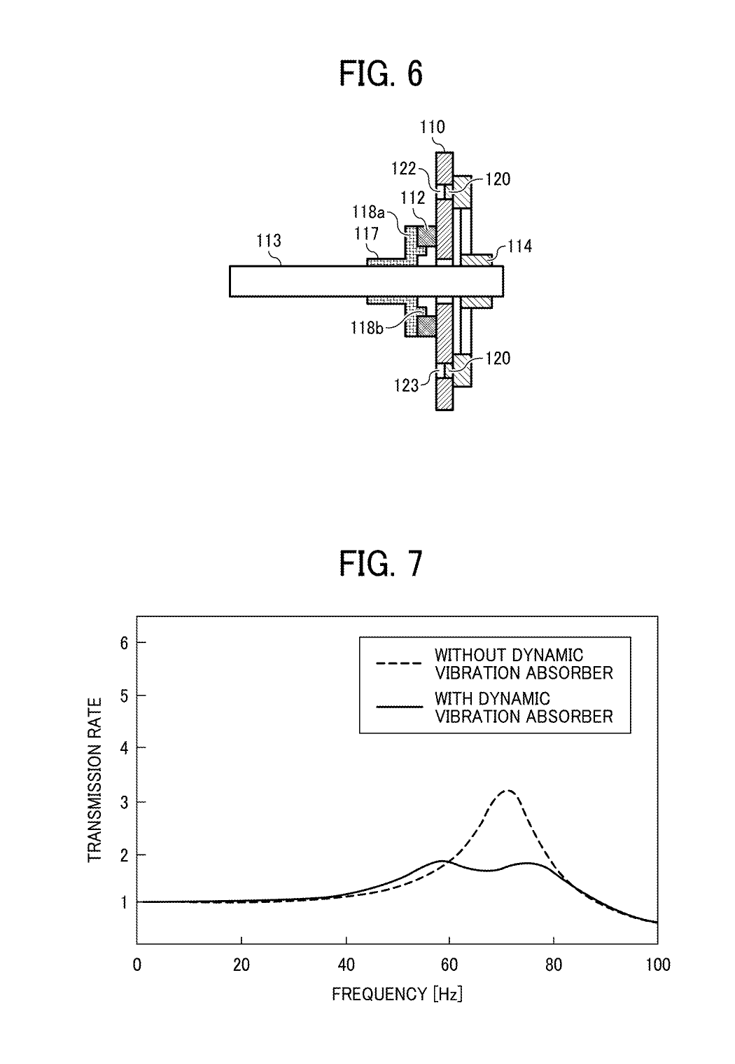

Now, yet another example of the torsion spring unit 111 capable of enhancing coaxial precision of the inertia body 110 in relation to the rotary shaft 113 by utilizing the torsion spring unit 111 is described with reference to FIGS. 5 and 6. As shown there, in a contact surface of the torsion spring unit 111 contacting the inertia body 110 (i.e., a backside of an outer rim of the torsion spring unit 111, which faces the flange 118a of the supporting unit 117), a pair of cylindrical protrusions 120 is formed diagonally to precisely position these members (i.e., the torsion spring unit 111 and the inertia body 110). These protrusions 120 are desirably placed on the opposite sides facing each other on a circumference on which the fixing screws 119 are also placed. Corresponding to the above-described protrusions 120, in the inertia body 110, there are established a round hole 122 and an oblong hole 123 to collectively position these members. These round and oblong holes 122 and 123 engage with the respective cylindrical protrusions of the torsion spring unit 111 and are screwed and locked.

In FIG. 7, frequency response characteristics obtained in a drive transmission system (i.e., a drivetrain) with the configuration of FIGS. 2 and 3 starting from the driving motor and ending at the photoconductive drum 1 acting as a rotator is shown. In the drawing, a dashed line indicates the frequency response characteristics obtained in a system without the dynamic vibration absorber 20, while a solid line indicates those of another system with the dynamic vibration absorber 20 on the drum shaft. As shown there, by installing the dynamic vibration absorber 20, a transmission rate in a resonance frequency is reduced in the drivetrain. Here, the above-described result is obtained by setting an inertia moment of the photoconductive drum 1 to about 9.5 kgm² while setting an inertia moment of the inertia body of the dynamic vibration absorber 20 to about 10% of that of the photoconductive drum 1, thereby optimizing a torsion spring constant and a viscous damping coefficient of the torsion spring unit 111 and the viscosity-providing component 112, respectively. It is recognized therefrom that the transmission rate amplified by the resonance frequency is greatly reduced by optimizing the dynamic vibration absorber 20. Accordingly, a variation in speed of the photoconductive drum 1 can be significantly reduced as a result.

The optimal value of the torsion spring constant cannot be defined and set solely by the torsion spring unit 111, because the viscosity-providing component 112 made of viscoelastic material of rubber also includes a spring factor. Hence, the torsion spring constant needs to be optimized and designed based on material and shapes of the torsion spring unit 111 and the viscosity-providing component 112 as well. In such a situation, if a spring component of the viscosity-providing component 112 is reduced as minimum as possible while dominantly setting that of the torsion spring unit 111, the torsion spring constant can be readily optimized. Therefore, a rigidity of the viscosity-providing component 112 is desirably set to be smaller, while setting that of the torsion spring unit 111 to be larger enough than the rigidity of the viscosity-providing component 112. Hence, in this example, the result is obtained by preparing and utilizing the torsion spring unit 111 made of polyacetal resin having a Young's modulus of about 2500 MPA, and the viscosity-providing component 112 made of NBR having a Young's modulus of about 1 MPa.

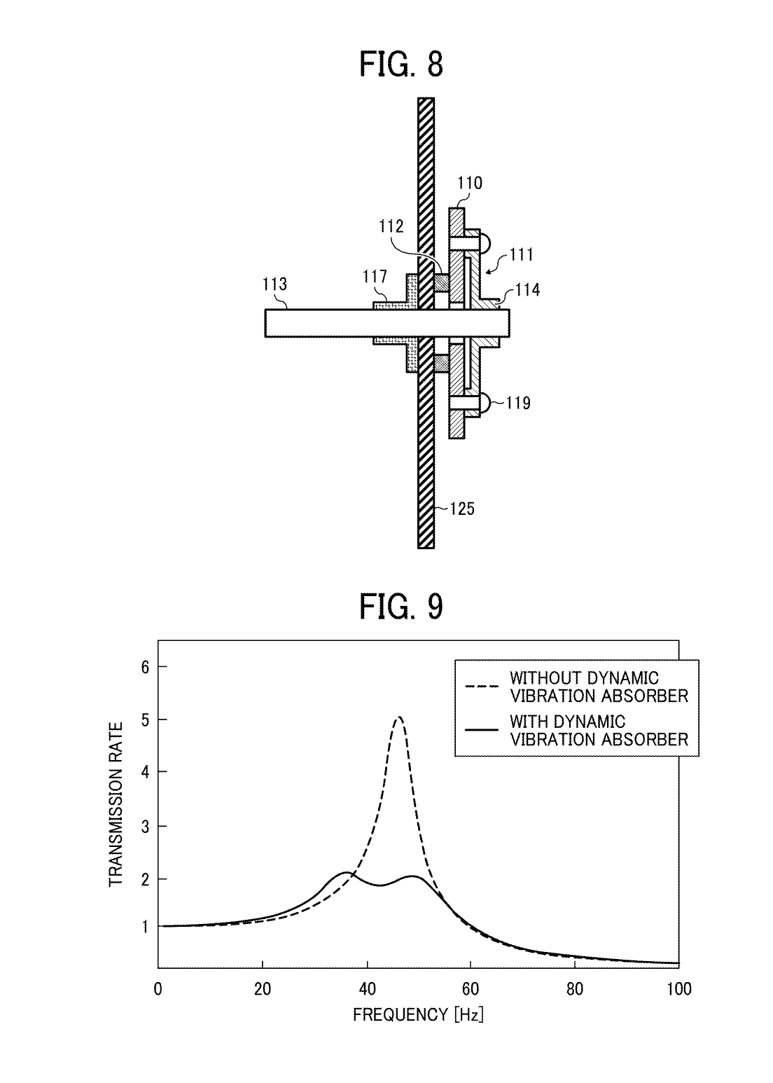

Now, a second embodiment of the present invention is described with reference to FIG. 8 and applicable drawings. As shown in FIG. 8, a dynamic vibration absorber 20 is attached to a rotary shaft 113 of a rotator driving system equipped with a flywheel that suppresses rotational fluctuation of a rotator. Specifically, the flywheel 125 is fixed to the supporting unit 117 and integrally rotates together with the rotary shaft 113. To an outer end face of the flywheel 125, a cylindrical viscosity-providing component 112 is glued or bonded coaxially with the flywheel 125 around the rotary shaft 113.

To another end face of the viscosity-providing component 112, an inertia body 110 of the dynamic vibration absorber 20 is glued coaxially with the rotary shaft 113 floating therefrom. The inertia body 110 is fixed and supported on a plane seat formed on an outer rim of the torsion spring unit 111 using screws 119. The torsion spring unit 111 has the similar shape as that of the example shown in FIGS. 3A to 3C. However, because the flywheel 125 is used here, a greater spring constant is necessarily used in this embodiment than that of the example of FIGS. 3A to 3C. Consequently, at least one of geometry parameters of the spoke 115, such as a cross section, a length, the number thereof, etc., necessarily grows.

Accordingly, in such a situation, even though the rotational fluctuation of the rotator can be typically reduced by the flywheel 125, a change in speed (i.e., the rotational fluctuation of the rotator) increases, by contrast, at a prescribed resonant frequency determined based on respective inertias of the flywheel 125 and the rotator and a rigidity of spring of the drivetrain. However, even in such a situation, the change or fluctuation can be minimized by the dynamic vibration absorber 20 as well.

In a system that includes the above-described driving system with the flywheel 125 shown in FIGS. 2 and 8, prescribed frequency response characteristics of the drive transmission system starting from the driving motor 16 and ending at the photoconductive drum 1 acting as the rotator are obtained as shown in FIG. 9. Again, a dashed line indicates the frequency response characteristics of the system without the dynamic vibration absorber 20, while a solid line indicates that of another system with the dynamic vibration absorber 20 on the drum shaft. It is noted from the graph that, with the flywheel, a transmission rate at a higher-frequency (e.g., more than 60 Hz in this case), at which conspicuous banding phenomenon (e.g. uneven density of stripes) easily appears, can be reduced thereby being capable of suppressing the rotational fluctuation of the rotator. By contrast, however, at approximately 50 Hz, since a resonance occurs depending on a torsion spring constant of a transmission system, the photoconductive drum 1, and the flywheel 125, and accordingly amplifies the transmission rate, fluctuation of the rotator grows at about this frequency band as a result. However, with the dynamic vibration absorber 20 installed, the transmission rate of the resonance frequency can be reduced while suppressing the rotational fluctuation. Hence, in this embodiment, the moments of inertia of the photoconductive drum 1 and the flywheel are set to about 9.5 kgm² and about 16.2 kgm², respectively, while setting the moment of inertia of the inertia body of the dynamic vibration absorber 20 to about ⅕ of that of the flywheel, for example. Thus, the graph of FIG. 9 shows a result obtained when the torsion spring constant and the viscous damping coefficient of the torsion spring unit 111 and the viscosity-providing component 112 are optimized, respectively.

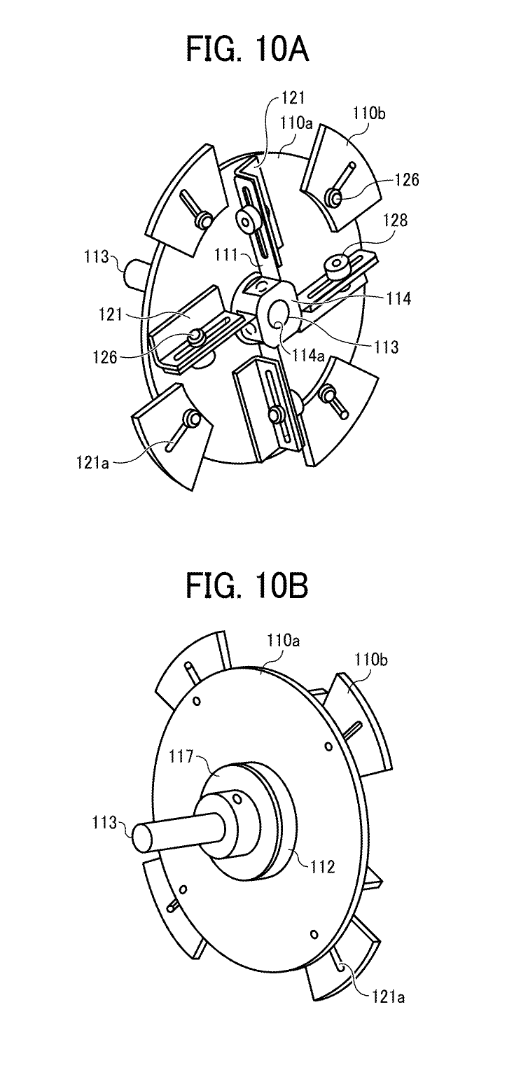

Now, yet another dynamic vibration absorber 20 according to a third embodiment of the present invention is described with reference to FIGS. 10A and 10B with perspective views. In this embodiment, even though the viscosity characteristics of rubber that constitutes the viscosity-providing component fluctuates, a dynamic vibration absorber 20 of this embodiment is set to an optimum condition to be able to effectively minimize a change in speed of a rotator).

Initially, various components of the dynamic vibration absorber 20 disposed around the rotary shaft 113 are described. The dynamic vibration absorber 20 includes a pair of inertia bodies, a torsion spring unit, and a viscosity-providing component as major components. Then, design parameters of these major components are optimized to work most effectively. Specifically, the inertia bodies of this embodiment include a disc-shaped first inertia body 110a and multiple second inertia bodies 110b fixed to the first inertia body 110a. These inertia bodies 110a and 110b are made of metal each to have a large inertia. There is provided a first inertia body hole 110c at a center of the first inertia body 110a as described later more in detail with reference to FIG. 13, so that the first inertia body 110a does not contact the rotary shaft 113.

The torsion spring unit 111 serves as a connecting part connecting the rotary shaft 113 with the inertia bodies 110a and 110b. Specifically, one end of the torsion spring unit 111 is connected to the rotary shaft 113 through a securing member (i.e., a boss 114), and the other end thereof is connected to the first inertia body 110a through a supporting bracket 121. Here, the torsion spring unit 111 is made of thin sheet metal. The supporting bracket 121 and the torsion spring unit 111 are roughly placed at the same position as each of the spokes 115 disposed in the above-described embodiment.

The viscosity-providing component 112 also serves as a connecting part to connect the rotary shaft 113 and the inertia bodies 110a and 110b with each other. Specifically, the viscosity-providing component 112 is connected to the rotary shaft 113 through the supporting unit 117, and is directly connected to the first inertia body 110a. The viscosity-providing component 112 is composed of rubber because higher viscosity can be set. For example, rubber, such as NBR, EPDM, NR, etc., is preferably employed.

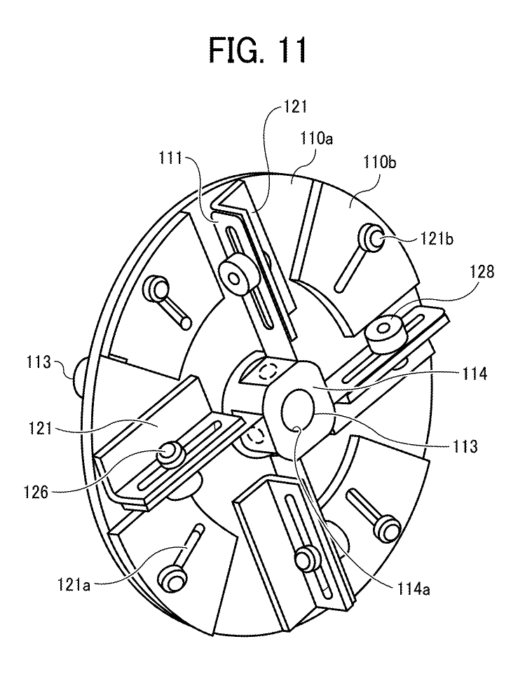

The second inertia bodies 110b can be moved in a radial direction from a boss hole 114a acting as a rotational center thereby changing its fixed position. In FIG. 10, the second inertia body 110b is fixed outermost from the center of rotation in the radial direction. By contrast, in FIG. 11, the second inertia body 110b is fixed innermost from the center of rotation (i.e., the boss hole 114a) in the radial direction. Specifically, the second inertia bodies 110b can be fixed at any position between the inner and outer-most positions shown in FIGS. 10 and 11 to adjust a moment of inertia as a dynamic vibration absorber 20.

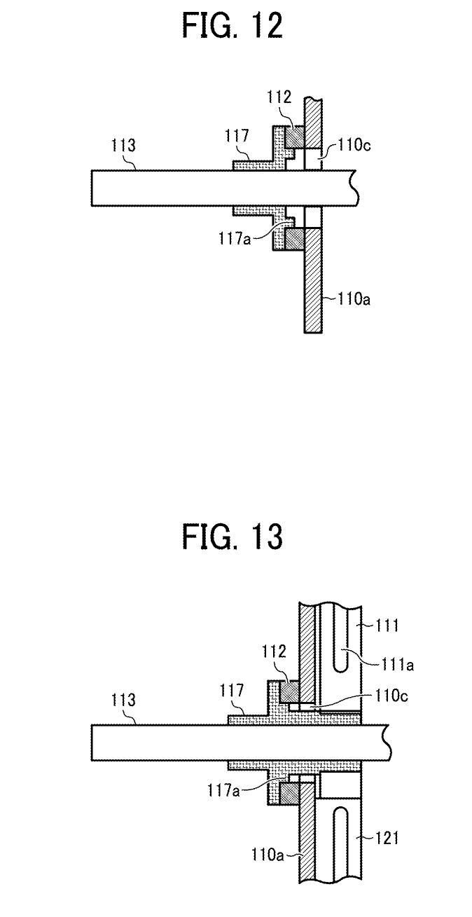

An aspect the viscosity-providing component 112 coupled to the first inertia body 110a and the rotatory shaft 113 through the supporting unit 117 is illustrated in FIG. 12 with its sectional view. As shown there, the viscosity-providing component 112 has a cylindrical shape and is glued to the supporting unit 117 and the first inertia body 110a as well. More specifically, a bore part of the viscosity-providing component 112 is glued to an annular protrusion 117a of the supporting unit 117 to obtain its coaxial precision by it.

Now, a modification of the viscosity-providing component 112 is described with reference to FIG. 13, in which a boss as a modification of the boss 114 as described with reference to FIG. 11 that fixes the multiple torsion spring units 111 and the supporting unit 117 to which the viscosity-providing component 112 is glued are integrated with each other and is herein below referred to as a supporting member united unit. As shown there, to the supporting member united unit, the torsion spring unit 111 is fixed and the viscosity-providing component 112 is glued at the same time as well. The supporting member united unit is fixed to the rotary shaft 113.

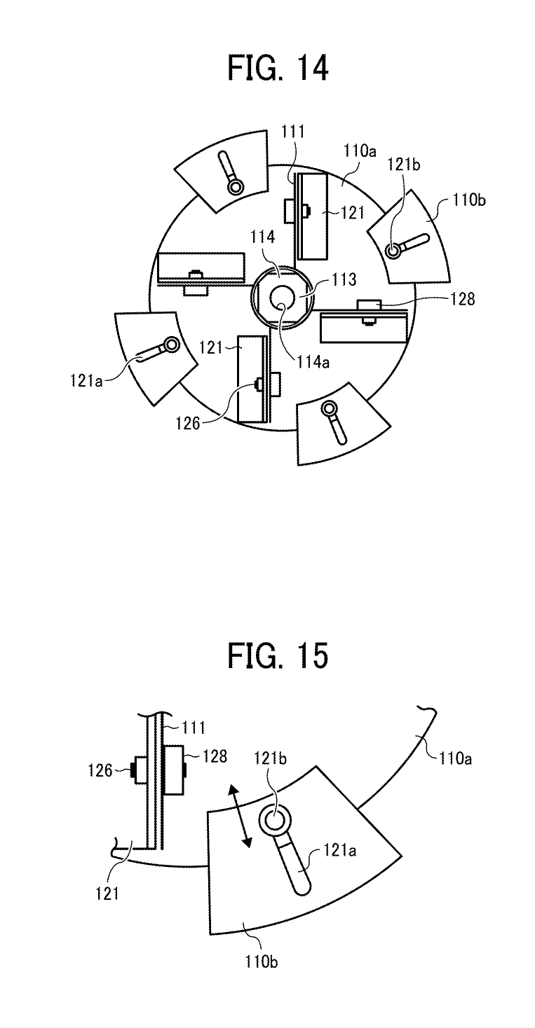

A front side view taken from an outside of the dynamic vibration absorber 20 is illustrated in FIG. 14. As shown there, the four torsion spring units 111 are provided at substantially equal angular intervals around rotary shaft 113. The four-second inertia bodies 110b are also provided at substantially equal angular intervals around rotary shaft 113, being positioned near a perimeter of the first inertia body 110a. Although the torsion spring units 111 and second inertia bodies 110b are provided at four places at substantially equal angular intervals, respectively, the number of places to provide these respective members are not limited to four and may include the other multiple values as well.

Now, the second inertia bodies 110b are described more in detail with reference to FIG. 15. Each of the second inertia bodies 110b is formed fanwise as shown in the drawing. More specifically, each of the second inertia bodies 110b has a fan shape having a prescribed size and angle possible to be attached between installation positions of the torsion spring units 111. Since an oblong hole 121a is formed in a middle portion of it, each of the second inertia bodies 110b can radially move in both directions as shown by an arrow from the center of rotation along the oblong holes 121a as shown in the drawing. Accordingly, each of the second inertia bodies 110b can be fixed to the first inertia body 110a at any position with a screw 121b. With this, inertia of the dynamic vibration absorber 20 can be adjusted. In addition, because the fixed position of the second inertia body 110b can be optionally changed, fine adjustment of the inertia becomes available.

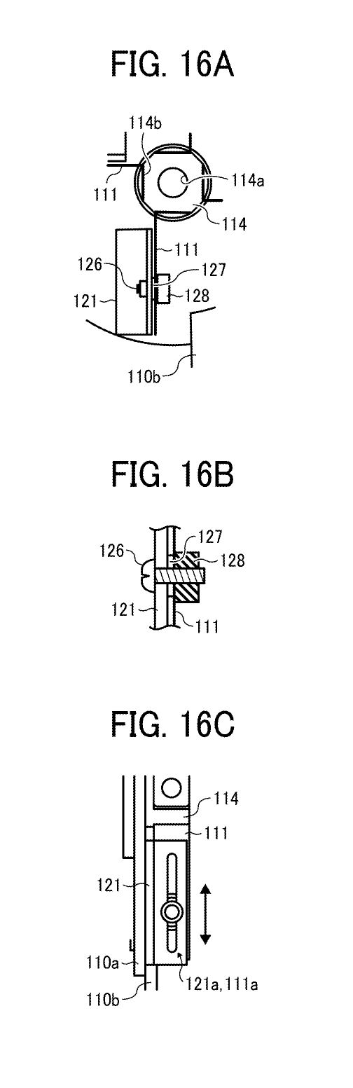

Now, a modification of the torsion spring units 111 is described more in detail with reference to FIGS. 16A to 16C. The torsion spring unit 111 as a spring member is prepared by bending a thin sheet metal in an L-shaped state and its shorter side portion is fixed to the boss 114. The boss 114 has a short axis having a boss hole 114a at its cross-sectional center. The boss 114 also has four planes 114b on its outer circumferential surface substantially at equal angular intervals. To these planes 114b, multiple bent portions (i.e., the shorter side portions) of the torsion spring unit 111 are fixed, respectively.

In the other portion of the torsion spring unit 111 (i.e., a longer portion), the oblong hole 111a is formed as shown in FIG. 16C. The other portion of the torsion spring unit 111 with this oblong hole 111a is fixed to a supporting bracket 121 fixed to the first inertia body 110a. The supporting bracket 121 has an L-shaped (i.e., an angle shaped) cross-section having an oblong hole on its plane as well, to which the torsion spring unit 111 is coupled.

Now, a method of coupling the torsion spring unit 111 to the supporting bracket 121 is described more in detail with reference to FIG. 16B. As shown there, a washer 127 is arranged between the torsion spring unit 111 and the supporting bracket 121. The torsion spring unit 111 and the supporting bracket 121 are fastened and coupled to each other with a screw 126 and a nut 128. If necessary, by loosening the nut 128, the screw 126, the washer 127, and the nut 128 are moved in a block along the oblong hole 111a in a direction as shown by arrow in FIG. 16C and are fixed at a prescribed optional position. With this, since a position at which the torsion spring unit 111 is coupled to the first inertia body 110a, (i.e., a distance from its base fixed to the boss 114) is changed, a spring constant of the torsion spring unit 111 can be adjusted. Moreover, because the fixed position can be optionally changed, fine adjustment of the spring constant becomes available. Here, when the screw 126 is tightly fastened, the torsion spring unit 111 engages with the washer 127 at its contact plane. Thus, the contact plane corresponds to the seat 116 as described in the earlier described embodiment.

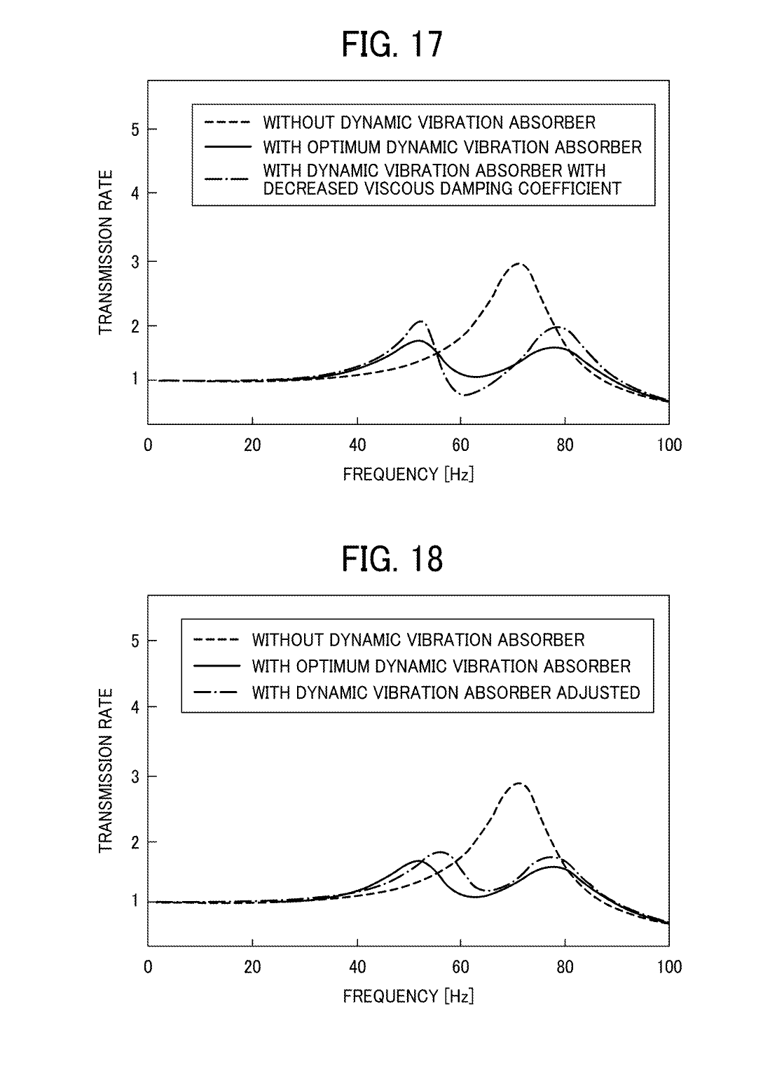

FIG. 17 indicates typical frequency response characteristics obtained when a viscous damping coefficient of the viscosity-providing component 112 made of rubber, which is included in the dynamic vibration absorber 20, decreases due to manufacturing variation generated in a production lot. As understood from the drawing, a transmission rate unfavorably grows far from an optimum condition. As a result, a change in speed unfavorably grows far from an optimum condition as well.

FIG. 18 illustrates a result of adjustment executed under the same condition when the viscous damping coefficient of the viscosity-providing component 112 decreases due to manufacturing variation generated in a production lot as described with reference to FIG. 17. As shown there, by adjusting the coupling position of the second inertia body 110b and the torsion spring unit 111, the inertia moment and the torsional spring constant are changed to meet with the optimum conditions in accordance with minimized viscosity characteristics. With this, dramatic worsening of the transmission rate far from the optimum condition shown in FIG. 17 can be likely prevented. Accordingly, growing of variation in speed far from the optimum condition can be minimized as well.

Here, the above-described inertia body can be made of metal having a heavy specific gravity. Although the inertia body has a circular shape in the above-described various embodiments as illustrated in the drawing, it is not limited thereto. Although the viscosity-providing component is made of viscoelastic material having the cylindrical shape as illustrated in the drawing, it is not limited thereto. Similarly, although four torsion spring units are provided as illustrated in the drawing, multiple torsion spring units may be acceptable and three or more torsion spring units may be more favorable. The torsion spring function member is preferably made of plastic. Further, the viscosity-providing component is preferably made of material capable of rendering its spring constant to be smaller than that of the torsion spring unit.

According to one aspect of the present invention, the inertia body can be coaxially held around a rotary shaft accurately, and accordingly the dynamic vibration absorber can effectively maintain prescribed spring and viscosity functions at the same time. That is, a novel rotator driving system for driving a rotator with a motor includes a dynamic vibration absorber attached to a rotary shaft of the rotator. The dynamic vibration absorber includes: an inertia body; and a viscosity-providing component to provide a viscosity; a torsion spring unit that includes a boss fixed to the rotary shaft, at least two spokes extending radially outward from the boss, and at least one seat provided at one of tips of the at least two spokes to fix the inertia body. The torsion spring unit is fixed by the rotary shaft of the rotator and the boss fixed to the rotary shaft. The torsion spring unit supports the inertia body via the at least one seat provided at one of tips of the at least two spokes.

According to another aspect of the present invention, the inertia body can be coaxially held around a rotary shaft more accurately, and accordingly the dynamic vibration absorber can more effectively maintain prescribed spring and viscosity functions at the same time. That is, a viscosity-providing component-supporting unit is connected to the rotary shaft, and the viscosity-providing component is sandwiched between and fixed to the viscosity-providing component-supporting unit and the inertia body.

According to yet another aspect of the present invention, the inertia body can be coaxially held around a rotary shaft more accurately, and accordingly the dynamic vibration absorber can more effectively maintain prescribed spring and viscosity functions at the same time. That is, the inertia body is supported by the torsion spring unit and the viscosity-providing component at its both end faces, respectively.

According to yet another aspect of the present invention, the inertia body can be coaxially held around a rotary shaft more accurately, and accordingly the dynamic vibration absorber can more effectively maintain prescribed spring and viscosity functions at the same time. That is, the inertia body is supported coaxially with the rotary shaft while floating above the rotary shaft.

According to yet another aspect of the present invention, the inertia body can be coaxially held around a rotary shaft more accurately, and accordingly the dynamic vibration absorber can more effectively maintain prescribed spring and viscosity functions at the same time. That is, each of the at least two spokes of the torsion spring unit includes a portion to enhance coaxial precision of the inertia body regarding the rotary shaft.

According to yet another aspect of the present invention, the inertia body can be coaxially held around a rotary shaft more accurately, and accordingly the dynamic vibration absorber can more effectively maintain prescribed spring and viscosity functions at the same time. That is, a flywheel is connected to the rotary shaft via a supporting unit fixed to the rotary shaft to suppress rotational fluctuation of the rotator. The inertia body is made of disc-shaped metal having a heavy specific gravity. The seat forms an outer ring extended over respective tips of the at least two spokes of the torsion spring unit. The viscosity-providing component is made of viscoelastic material having a cylindrical shape, and is sandwiched between and fixed to the flywheel and the inertia body.

According to yet another aspect of the present invention, the inertia body can be coaxially held around a rotary shaft more accurately, and accordingly the dynamic vibration absorber can more effectively maintain prescribed spring and viscosity functions at the same time. That is, the rotator driving system includes a dynamic vibration absorber attached to a rotary shaft of a rotator. The dynamic vibration absorber includes a first inertia body not fixed to the rotary shaft in its rotational direction, at least two torsion spring units each extending radially outward from the rotary shaft while connecting to the first inertia body and the rotary shaft at its both ends, respectively, a viscosity-providing component supporting unit fixed to the rotary shaft, a viscosity-providing component made of viscoelastic rubber connected to the first inertia body and the rotary shaft via the viscosity-providing component supporting unit. An amount of inertia and a spring constant of the dynamic vibration absorber are adjusted by moving a coupling position of the torsion spring unit coupled with the first inertia body in the radial direction in accordance with a variation in viscosity characteristics of the viscosity-providing component.

According to yet another aspect of the present invention, the inertia body can be coaxially held around a rotary shaft more accurately, and accordingly the dynamic vibration absorber can more effectively maintain prescribed spring and viscosity functions at the same time. That is, at least two second inertia bodies are attached to the first inertia body.

According to yet another aspect of the present invention, the inertia body can be coaxially held around a rotary shaft more accurately, and accordingly the dynamic vibration absorber can more effectively maintain prescribed spring and viscosity functions at the same time. That is, a torsion spring unit securing member is secured to the rotary shaft to secure the at least two torsion spring units at its one end. At least two inertia body supporting brackets are fixed to the first inertia body. Each of the at least two inertia body supporting brackets has a first slot with its longer axis extended in a radial direction. Each of the at least two torsion spring units is a metal plate spring extended in the radial direction forming a right angle with the first inertia body. The metal plate spring of each of the at least two torsion spring units has a second slot with its longer axis extended in the radial direction. Each of the at least two torsion spring units is fastened to corresponding one of the supporting brackets with a screw at an optional position in each of the first and second slots of each of the torsion spring units and that of the supporting brackets.

According to yet another aspect of the present invention, the inertia body can be coaxially held around a rotary shaft more accurately, and accordingly the dynamic vibration absorber can more effectively maintain prescribed spring and viscosity functions at the same time. That is, each of the second inertia bodies has a third slot with a longer axis extended in the radial direction. Each of the second inertia bodies is fastened to the first inertia body with a screw at an optional position in the third slot.

According to yet another aspect of the present invention, the inertia body can be coaxially held around a rotary shaft more accurately, and accordingly the dynamic vibration absorber can more effectively maintain prescribed spring and viscosity functions at the same time. That is, the torsion spring unit securing member and the viscosity-providing component supporting unit are integrally configured in a body.

Numerous additional modifications and variations of the present invention are possible in light of the above teachings. It is therefore to be understood that within the scope of the appended claims, the present invention may be executed otherwise than as specifically described herein. For example, the rotator driving system and the image forming apparatus with the same are not limited to the above-described various embodiments and may be altered as appropriate.

What is claimed is:

1. A rotator driving system for driving a rotator, the rotator driving system comprising a dynamic vibration absorber attached to a rotary shaft of the rotator, the dynamic vibration absorber comprising:
an inertia body;
a viscosity-providing component to take charge of a viscosity function; and
a torsion spring unit to take charge of a torsion spring function, the torsion spring unit including:
a boss fixed to the rotary shaft;
at least two spokes extending radially outward from the boss; and
at least one seat provided at one of tips of the at least two spokes to fix the inertia body,
wherein the torsion spring unit is fixed to the rotary shaft of the rotator via the boss fixed to the rotary shaft, the torsion spring unit supporting the inertia body via the at least one seat provided at one of tips of the at least two spokes.

2. The rotator driving system as claimed in claim 1, further comprising a viscosity-providing component supporting unit connected to the rotary shaft,
wherein the viscosity-providing component is sandwiched between and fixed to the viscosity-providing component supporting unit and the inertia body.

3. The rotator driving system as claimed in claim 1, wherein the inertia body is supported at both end faces thereof by the torsion spring unit and the viscosity-providing component, respectively.

4. The rotator driving system as claimed in claim 1, wherein the inertia body is supported by the torsion spring unit and the viscosity-providing component coaxially with the rotary shaft while floating above the rotary shaft.

5. The rotator driving system as claimed in claim 1, wherein each of the at least two spokes of the torsion spring unit includes a portion configured to enhance coaxial positioning precision of the inertia body with respect to the rotary shaft.

6. The rotator driving system as claimed in claim 1, further comprising a flywheel to suppress rotational fluctuation of the rotator, the flywheel connected to the rotary shaft via a supporting unit fixed to the rotary shaft;
wherein the inertia body is a metal disc having a heavy specific gravity,
wherein the at least one seat forms an outer ring extended over respective tips of the at least two spokes of the torsion spring unit,
wherein the viscosity-providing component is a viscoelastic material having a cylindrical shape, the viscosity-providing component being sandwiched between and fixed to the flywheel and the inertia body.

7. A rotator driving system for driving a rotator, the rotator driving system comprising a dynamic vibration absorber attached to a rotary shaft of the rotator, the dynamic vibration absorber comprising:
a first inertia body not fixed to the rotary shaft in a rotational direction of the rotary shaft;
at least two torsion spring units each extending radially outward from the rotary shaft while connecting to the first inertia body and the rotary shaft at both ends thereof, respectively;
a viscosity-providing component supporting unit fixed to the rotary shaft; and
a viscosity-providing component made of viscoelastic rubber connected to the first inertia body and the rotary shaft via the viscosity-providing component supporting unit,
wherein an amount of inertia and a spring constant of the dynamic vibration absorber are adjustable by adjusting a coupling position of the torsion spring unit coupled with the first inertia body in the radial direction in accordance with a variation in viscosity characteristics of the viscosity-providing component.

8. The rotator driving system as claimed in claim 7, wherein the dynamic vibration absorber further comprises at least two second inertia bodies attached to the first inertia body.

9. The rotator driving system as claimed in claim 7, further comprising:
a torsion spring unit securing member secured to the rotary shaft to secure the at least two torsion spring units at an one end thereof; and
at least two inertia body supporting brackets fixed to the first inertia body, each of the at least two inertia body supporting brackets having a first slot with a longer axis of the first slot extended in a radial direction,
wherein each of the at least two torsion spring units is a metal plate spring extended in the radial direction while forming a right angle with the first inertia body, the metal plate spring of each of the at least two torsion spring units having a second slot with a longer axis of the second slot extended in the radial direction,
wherein each of the at least two torsion spring units is fastened to a corresponding one of the supporting brackets with a screw at an optional position in the first slot and the second slot of the torsion spring unit and the corresponding one of supporting brackets, respectively.

10. The rotator driving system as claimed in claim 9, wherein the dynamic vibration absorber further comprises at least two second inertia bodies attached to the first inertia body, and
wherein each of the at least two second inertia bodies has a third slot with a longer axis of the third slot extended in the radial direction, the each of the at least two second inertia bodies being fastened to the first inertia body with a screw at an optional position in the third slot.

11. The rotator driving system as claimed in claim 10, wherein the torsion spring unit securing member and the viscosity-providing component supporting unit form a single integrated unit.

12. An image forming apparatus comprising:
a rotator with a rotary shaft; and
a rotator driving system to drive the rotator, the rotator driving system including a dynamic vibration absorber attached to the rotary shaft of the rotator, the dynamic vibration absorber comprising:
an inertia body;
a viscosity-providing component to provide a viscosity; and
a torsion spring unit including:
a boss fixed to the rotary shaft,
at least two spokes extending radially outward from the boss, and
at least one seats provided at one of tips of the at least two spokes to fix the inertia body,
wherein the torsion spring unit is fixed to the rotary shaft of the rotator via the boss fixed to the rotary shaft, the torsion spring unit supporting the inertia body via the at least one seats provided at one of tips of the at least two spokes.

13. The image forming apparatus as claimed in claim 12, further comprising a viscosity-providing component supporting unit connected to the rotary shaft,
wherein the viscosity-providing component is sandwiched between and fixed to the viscosity-providing component supporting unit and the inertia body.

14. The image forming apparatus as claimed in claim 12, wherein the inertia body is supported by the torsion spring unit and the viscosity-providing component at both end faces thereof, respectively.

15. The image forming apparatus as claimed in claim 12, wherein the inertia body is supported coaxially with the rotary shaft while floating above the rotary shaft.

16. The image forming apparatus as claimed in claim 12, wherein each of the at least two spokes of the torsion spring unit includes a portion configured to enhance coaxial positional precision of the inertia body with respect to the rotary shaft.

17. The image forming apparatus as claimed in claim 12, further comprising:
a flywheel to suppress rotational fluctuation of the rotator, the flywheel connected to the rotary shaft via a supporting unit fixed to the rotary shaft,
wherein the inertia body is a metal disc having a heavy specific gravity, wherein the at least one seat forms an outer ring extended over respective tips of the at least two spokes of the torsion spring unit,
wherein the viscosity-providing component is a viscoelastic material having a cylindrical shape, the viscosity-providing component being sandwiched between and fixed to the flywheel and the inertia body.
